(19) United States
(12) Patent Application Publication
(10) Pub. No.: US 2026/0300140 A1
(43) Pub. Date: Oct. 1, 2026

(54) AUTOMATED IDENTIFICATION AND EXECUTION OF SOFTWARE TESTS

(71) Applicant: Dell Products L.P., Round Rock, TX (US)

(72) Inventors: Alexander Shteingart, Nahariya (IL); Alexander Zvansky, Haifa (IL)

(21) Appl. No.: 19/093,881

(22) Filed: Mar. 28, 2025

(51) Int. Cl. G06F 11/3668

(52) U.S. Cl. CPC G06F 11/3676; G06F 11/3684; G06F 11/3688

(57) ABSTRACT

Techniques are provided for automated identification of software tests using code coverage analysis and software tests designated for inclusion. One method comprises obtaining a first set of software tests and a corresponding code coverage statistic for the software tests in the first set, wherein the first set comprises software tests designated for inclusion; selecting software tests in the first set for inclusion in a second set based on an evaluation of the code coverage statistic for software tests in the first set, wherein the evaluation of the code coverage statistic comprises evaluating whether the code coverage statistic for at least some of the software tests in the first set satisfies one or more code coverage variance criteria, and wherein the second set comprises the software tests from the first set designated for inclusion; and automatically initiating an execution of the software tests in the second set.

### BACKGROUND

Information processing systems include a wide variety of information technology (IT) assets that execute software applications, for example. It is often necessary to execute software tests to evaluate one or more software items, such as a given software product. As a given software item matures, new functionality may be added, or existing functionality may be modified, and additional software tests may be needed. Thus, the number of software tests associated with the given software item can become prohibitive.

### SUMMARY

Illustrative embodiments of the disclosure provide techniques for automated identification and execution of software tests (e.g., using code coverage analysis and software tests designated for inclusion). One method includes accessing at least one data structure comprising information characterizing a first set of software tests that evaluate one or more software items and at least one code coverage statistic for respective ones of the software tests in the first set, wherein the first set comprises one or more software tests designated for inclusion; selecting one or more of the software tests in the first set for inclusion in a second set of software tests based at least in part on an evaluation of the at least one code coverage statistic for at least some of the software tests in the first set, wherein the evaluation of the at least one code coverage statistic comprises evaluating whether the at least one code coverage statistic for at least some of the software tests in the first set satisfies one or more code coverage variance criteria, and wherein the second set comprises the one or more software tests from the first set designated for inclusion; and automatically initiating an execution of one or more of the software tests in the second set.

Illustrative embodiments can provide significant advantages relative to conventional techniques. For example, technical problems related to such conventional techniques are mitigated in one or more embodiments by automatically identifying software tests for inclusion in at least one test suite by evaluating code coverage statistics and one or more code coverage variance criteria.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for automated identification of software tests using code coverage analysis and software tests designated for inclusion in accordance with an illustrative embodiment;

FIG. 2 is a sample table illustrating a number of variables and metrics employed by the software application test suite selection system of FIG. 1 in accordance with an illustrative embodiment;

FIG. 3 is a process diagram illustrating an exemplary process for automated identification of software tests in accordance with an illustrative embodiment;

FIG. 4 is a flow diagram illustrating an exemplary implementation of a process for automated identification of software tests using code coverage analysis and software tests designated for inclusion in accordance with an illustrative embodiment;

FIG. 5 illustrates an exemplary processing platform that may be used to implement at least a portion of one or more embodiments of the disclosure comprising a cloud infrastructure; and

FIG. 6 illustrates another exemplary processing platform that may be used to implement at least a portion of one or more embodiments of the disclosure.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

While a large number of software tests as part of a regression cycle can be beneficial from a quality perspective, it also presents a number of significant challenges. Actively used software tests require maintenance, such as aligning with changes in the software product and stabilizing automation. Executing multiple software tests requires a long time or a substantially large amount of computing resources. A long regression cycle may prevent an organization from achieving short release cycles, which is typically a desired goal. As the necessary test suite continuously expands, the test suite may require increasingly more time and computing resources.

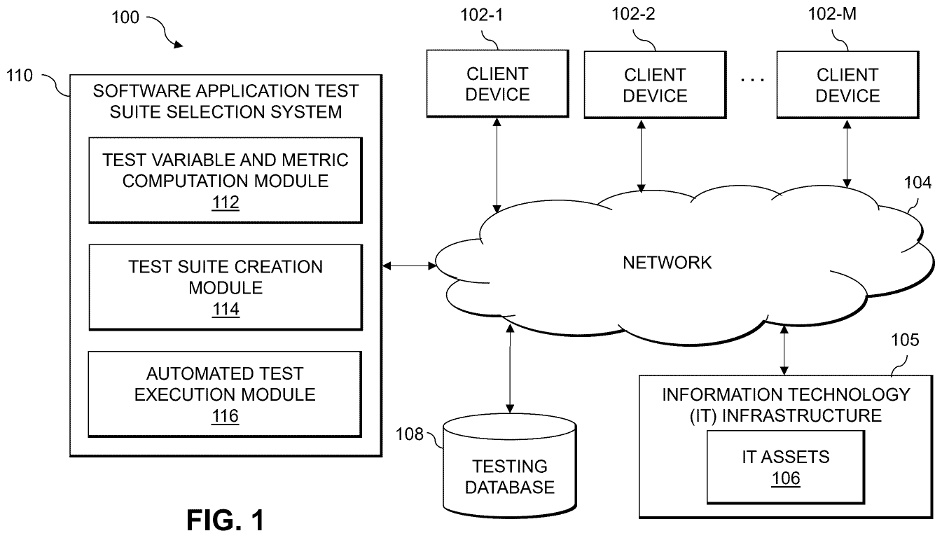

FIG. 1 shows an information processing system 100 configured in accordance with an illustrative embodiment. The information processing system 100 is assumed to be built on at least one processing platform and provides functionality for automated identification of software tests using code coverage analysis and software tests designated for inclusion. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a testing database 108, and a software application test suite selection system 110. The IT assets 106 may comprise physical and/or virtual computing resources in the IT infrastructure 105. Physical computing resources may include physical hardware such as servers, host devices, storage systems, networking equipment, Internet of Things (IoT) devices, other types of processing and computing devices including desktops, laptops, tablets, smartphones, etc. Virtual computing resources may include virtual machines (VMs), containers, etc.

The IT assets 106 of the IT infrastructure 105 may host software applications and/or other software that may be utilized by respective ones of the client devices 102, such as in accordance with a client-server computer program architecture. In some embodiments, the software applications comprise web applications designed for delivery from assets in the IT infrastructure 105 to users (e.g., of client devices 102) over the network 104. Various other examples are possible, such as where one or more software applications are used internal to the IT infrastructure 105 and not exposed to the client devices 102. It should be appreciated that, in some embodiments, some of the IT assets 106 of the IT infrastructure 105 may themselves be viewed as applications or more generally software or hardware that is to be evaluated. For example, individual ones of the IT assets 106 that are virtual computing resources implemented as software containers may represent software that is to be evaluated.

It is to be appreciated that the term “user” in this context and elsewhere herein is intended to be broadly construed so as to encompass, for example, human, hardware, software or firmware entities, as well as various combinations of such entities.

The software application test suite selection system 110 utilizes various information stored in the testing database 108, such as execution logs providing information obtained from prior executions of one or more software tests on various IT assets 106. In some embodiments, the software application test suite selection system 110 is used for an enterprise system. For example, an enterprise may subscribe to or otherwise utilize the software application test suite selection system 110 to automatically select software application test suites. As used herein, the term “enterprise system” is intended to be construed broadly to encompass any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The testing database 108, as discussed above, is configured to store and record various information, such as execution logs providing information obtained from prior executions of one or more test cases on various IT assets 106, which is used by the software application test suite selection system 110 to automatically identify software tests for a test suite. Such information may include, but is not limited to, information regarding execution of one or more software applications, software tests, test cases, testing objectives, testing points, test coverage, testing plans, etc. The testing database 108 in some embodiments is implemented using one or more storage systems or devices associated with the software application test suite selection system 110. In some embodiments, one or more of the storage systems utilized to implement the testing database 108 comprise a scale-out all-flash content addressable storage array or other type of storage array.

The term “storage system” as used herein is therefore intended to be broadly construed and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the software application test suite selection system 110, as well as to support communication between the software application test suite selection system 110 and other related systems and devices not explicitly shown.

The client devices 102 are configured to access or otherwise utilize the IT infrastructure 105. In some embodiments, the client devices 102 are assumed to be associated with users that execute one or more software applications or other software. In other embodiments, the client devices 102 are assumed to be associated with system administrators, IT managers or other authorized personnel responsible for managing the IT assets 106 of the IT infrastructure 105 (e.g., where such management includes performing testing of the IT assets 106, or of applications or other software that runs on the IT assets 106). For example, a given one of the client devices 102 may be operated by a user to access a graphical user interface (GUI) provided by the software application test suite selection system 110 to manage the generation of testing plans (e.g., create, review, execute, etc.). The software application test suite selection system 110 may be provided as a cloud service that is accessible by the given client device 102 to allow the user thereof to manage testing plans. In some embodiments, the IT assets 106 of the IT infrastructure 105 are owned or operated by the same enterprise that operates the software application test suite selection system 110 (e.g., where an enterprise such as a business provides support for the assets it operates). In other embodiments, the IT assets 106 of the IT infrastructure 105 may be owned or operated by one or more enterprises different than the enterprise which operates the software application test suite selection system 110 (e.g., a first enterprise provides support for assets that are owned by multiple different customers, business, etc.). Various other examples are possible.

In other embodiments, the software application test suite selection system 110 may be operated by a software vendor that produces and sells software (e.g., applications) that executes, at least in part, on the client devices 102. The software application test suite selection system 110, however, is not required to be operated by any single hardware or software vendor. Instead, the software application test suite selection system 110 may be offered as a service to provide support for computing devices or software that are sold by any number of hardware or software vendors. The client devices 102 may subscribe to the software application test suite selection system 110, so as to provide support for testing and/or evaluation of software, such as software executing on the client devices 102. Various other examples are possible.

In some embodiments, the client devices 102 may implement host agents that are configured for automated transmission of information regarding a state of the client devices 102 (e.g., such as in the form of testing and/or execution logs periodically provided to the testing database 108 and/or the software application test suite selection system 110). Such host agents may also or alternatively be configured to automatically receive from the software application test suite selection system 110 commands to execute remote actions (e.g., to run various software tests, or portions thereof, and/or test cases on the client devices 102 and/or the IT assets 106 of the IT infrastructure 105). Host agents may similarly be deployed on the IT assets 106 of the IT infrastructure 105.

It should be noted that a “host agent” as this term is generally used herein may comprise an automated entity, such as a software entity running on a processing device. Accordingly, a host agent need not be a human entity.

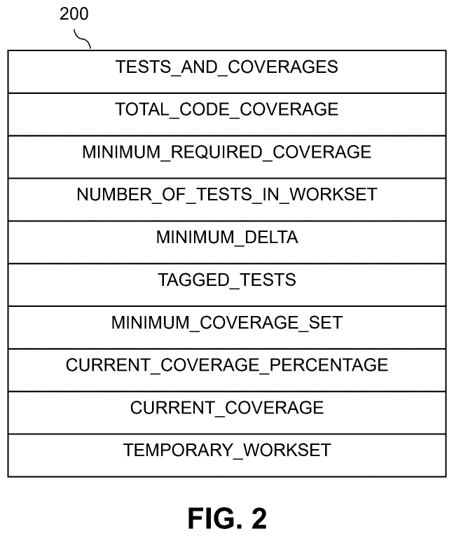

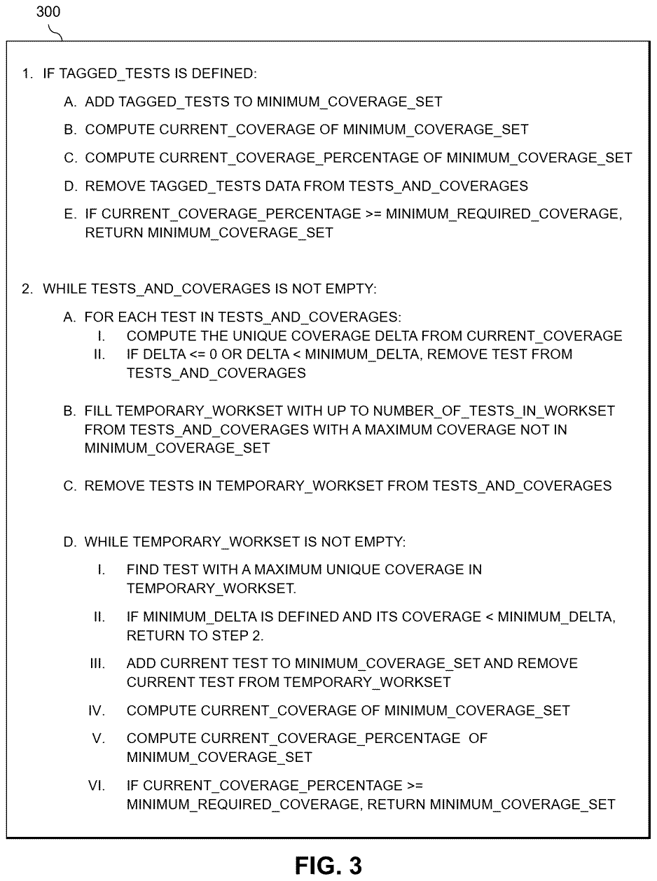

The software application test suite selection system 110 in the FIG. 1 embodiment is assumed to be implemented using at least one processing device. Each such processing device generally comprises at least one processor and an associated memory, and implements one or more functional modules or logic for controlling certain features of the software application test suite selection system 110. In the FIG. 1 embodiment, the software application test suite selection system 110 comprises a test variable and metric computation module 112, a test suite creation module 114 and an automated test execution module 116. The test variable and metric computation module 112 may be configured to manage the computation of various variables, metrics, statistics or other values used to automatically identify software tests for inclusion in one or more test suites, as discussed further below in conjunction with FIGS. 2 and 3, for example. The test suite creation module 114 may be configured to automatically identify software tests for inclusion in one or more test suites using the various values generated by the test variable and metric computation module 112, as discussed further below in conjunction with FIG. 3. The automated test execution module 116 is further configured, either directly or via one or more of the client devices 102, to execute the one or more software tests, or portions thereof, in a given generated test suite, for example, using the IT assets 106 of the IT infrastructure 105, as would be apparent to a person of ordinary skill in the art.

It is to be appreciated that this particular arrangement of modules 112, 114 and/or 116 illustrated in the software application test suite selection system 110 of the FIG. 1 embodiment is presented by way of example only, and alternative arrangements can be used in other embodiments. For example, the functionality associated with the modules 112, 114 and/or 116 in other embodiments can be combined into a single module, or separated across a larger number of modules. As another example, multiple distinct processors can be used to implement different ones of the modules 112, 114 and/or 116 or portions thereof.

At least portions of modules 112, 114 and/or 116 may be implemented at least in part in the form of software that is stored in memory and executed by a processor.

The at least one processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

A network interface may allow the software application test suite selection system 110 to communicate over the network 104 with the client devices 102, and illustratively comprises one or more conventional transceivers.

It is to be appreciated that the particular arrangement of the client devices 102, the IT infrastructure 105 and the software application test suite selection system 110 illustrated in the FIG. 1 embodiment is presented by way of example only, and alternative arrangements can be used in other embodiments. As discussed above, for example, the software application test suite selection system 110 (or portions of components thereof, such as one or more of the test variable and metric computation module 112, the test suite creation module 114 and the automated test execution module 116) may in some embodiments be implemented internal to one or more of the client devices 102 and/or the IT infrastructure 105.

The software application test suite selection system 110 and other portions of the information processing system 100, as will be described in further detail below, may be part of cloud infrastructure.

The software application test suite selection system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the testing database 108 and the software application test suite selection system 110 or components thereof (e.g., the test variable and metric computation module 112, the test suite creation module 114 and the automated test execution module 116) may be implemented on respective distinct processing platforms, although numerous other arrangements are possible. For example, in some embodiments at least portions of the software application test suite selection system 110 and one or more of the client devices 102, the IT infrastructure 105 and/or the testing database 108 are implemented on the same processing platform. A given client device (e.g., client device 102-1) can therefore be implemented at least in part within at least one processing platform that implements at least a portion of the software application test suite selection system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the testing database 108 and the software application test suite selection system 110, or portions or components thereof, to reside in different data centers. Numerous other distributed implementations are possible. The software application test suite selection system 110 can also be implemented in a distributed manner across multiple data centers.

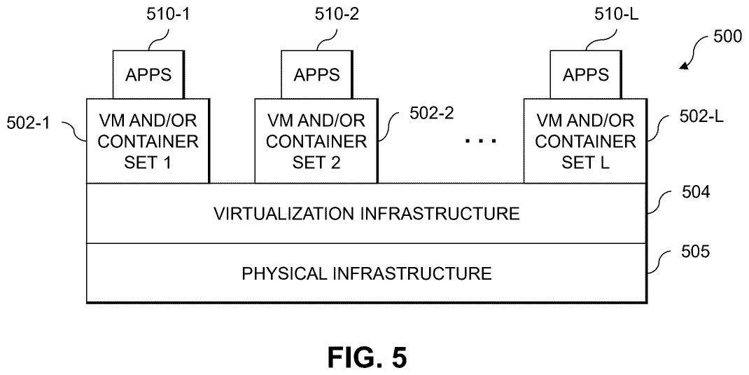

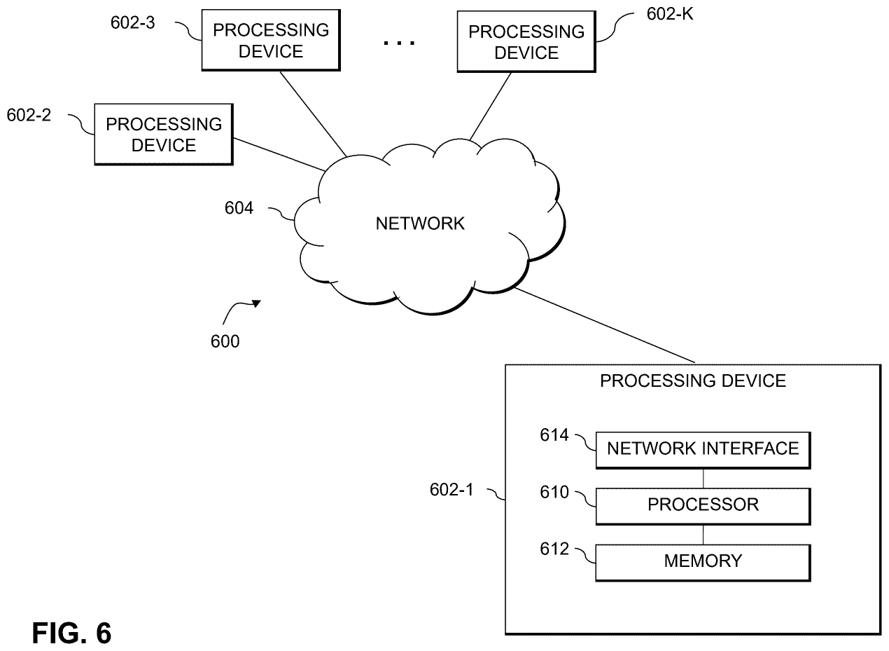

Additional examples of processing platforms utilized to implement the software application test suite selection system 110 and other components of the information processing system 100 in illustrative embodiments will be described in more detail below in conjunction with FIGS. 5 and 6.

It is to be appreciated that these and other features of illustrative embodiments are presented by way of example only and should not be construed as limiting in any way.

It is to be understood that the particular set of elements shown in FIG. 1 for automated identification of software tests using code coverage analysis and software tests designated for inclusion is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only and should not be construed as limiting in any way.

FIG. 2 is a sample table 200 illustrating a number of variables and metrics employed by the software application test suite selection system 110 of FIG. 1 in accordance with an illustrative embodiment. In the example of FIG. 2, a tests_and_coverages list is maintained that identifies each software test in a test library and one or more corresponding test coverage statistics for each software test. The one or more corresponding test coverage statistics may be based, for example, on covered lines, covered functions, covered branches, covered statements and/or other coverage metrics associated with the respective software tests, as would be apparent to a person of ordinary skill in the art.

In some embodiments, a total_code_coverage metric indicates a total code coverage of all of the software tests in the test library. A minimum_required_coverage metric may be defined to indicate a minimal requested code coverage percentage (e.g., less than or equal to 100%). A number_of_tests_in_workset variable may be defined to indicate a number of software tests to process in each iteration. A minimum_delta metric may be defined to indicate a minimum variance in coverage for a given software test compared to other software tests before the given software test is added to the test library. The minimum_delta metric may serve as a threshold to prevent an inclusion of software tests that add only marginally unique coverage. Setting the minimum_delta metric too low may lead to a selection of too many software tests, while setting the minimum_delta metric too high may result in insufficient coverage. The minimum_delta metric may be tailored in some embodiments based on the characteristics of a given test suite.

In one or more embodiments, a tagged_tests set may be defined to identify a group of tests that have been designated for inclusion (e.g., mandatory software tests) in a software testing cycle (e.g., a regression cycle). Including the tagged_tests set in the automatic software test identification algorithm may serve as a compromise with traditional scenario-based test selection techniques. A minimum_coverage_set may be initialized as an empty list and, over time, can be populated to provide a final list of software tests for execution. A current_coverage_percentage variable can be initialized to zero and can provide a current code coverage, in percent, of the minimum_coverage_set. A current_coverage list may be initialized as an empty list and, over time, can indicate the joined coverage of the minimum_coverage_set. A temporary_workset may be initialized as an empty list and can be used as a temporary list of tests to be processed in each iteration.

FIG. 3 is a process diagram illustrating an exemplary process 300 for automated identification of software tests in accordance with an illustrative embodiment. In the example of FIG. 3, if a tagged_tests set is defined in step 1, the software tests in the tagged_tests set are added to the minimum_coverage_set in step 1A. The current_coverage (e.g., the cumulative coverage) of the minimum_coverage_set is computed in step 1B. The current_coverage_percentage (e.g., the percent of cumulative coverage) of the minimum_coverage_set is computed in step 1C. The software tests in the tagged_tests set are then removed from the tests_and_coverages list in step 1D. If the current_coverage_percentage is greater than or equal to the minimum_required_coverage, the exemplary process 300 of FIG. 3 returns the minimum_coverage_set in step 1E.

A loop is entered in step 2 that is performed while the tests_and_coverages list is not empty. In step 2A, for each software test in tests_and_coverages, the unique coverage delta is computed in step 2A. I from the current_coverage list. If the unique coverage delta is less than or equal to 0, or if the unique coverage delta is less than minimum_delta, the software test is removed from the tests_and_coverages list in step 2A. II.

The temporary_workset is filled in step 2B with up to the number of tests designated by the number_of_tests_in_workset variable, from the tests_and_coverages list, having a maximum coverage that is not in the minimum_coverage_set. The software tests in the temporary_workset are removed from the tests_and_coverages list in step 2C.

In step 2D, while the temporary_workset is not empty, a software test with a maximum unique coverage in the temporary_workset is found in step 2D.I. If the minimum_delta is defined in step 2D. II, and its coverage is less than minimum_delta, program control returns to step 2. The current software test is added to the minimum_coverage_set in step 2D. III and the current test is removed from the temporary_workset. The current_coverage is computed in step 2D. IV of the minimum_coverage_set. The current_coverage_percentage of the minimum_coverage_set is computed in step 2D.V. If the current_coverage_percentage is greater than or equal to the minimum_required_coverage, the minimum_coverage_set is returned in step 2D. VI.

In at least some embodiments, the exemplary process 300 of FIG. 3 constructs a minimal set of software tests that meets the required coverage, for example, using a combination of code coverage metrics and static analysis. Tagged tests are considered first, and then a filtering based on coverage deltas is performed. Thereafter, the exemplary process 300 gradually builds a minimum_coverage_set until the required coverage is met, or all software tests have been processed.

In at least some embodiments, an assumption may be made that there may be some overlap in coverage of the software tests in the software test library. Software tests used for regression testing, for example, are typically written using a scenario-based approach and often exhibit significant overlap in terms of code coverage. Therefore, it is reasonable to assume that a non-negligible number of these software tests can be excluded from test suites, such as regression test suites, as they may be represented by a combination of one or more other software tests.

In one or more embodiments, given the above-noted coverage overlap, the disclosed techniques for automated identification of software tests using code coverage analysis and software tests designated for inclusion can converge on a set of tests that meets or exceeds the required cumulative coverage, typically in fewer iterations than the total number of available tests.

While the worst-case complexity of the disclosed automatic software test identification techniques may be expressed as O(N²), practical scenarios with significant overlap and a lower target coverage suggest that the average time complexity could trend towards O(N log N) (especially when aiming for coverage below 100%, as fewer iterations would be required to meet the coverage goals).

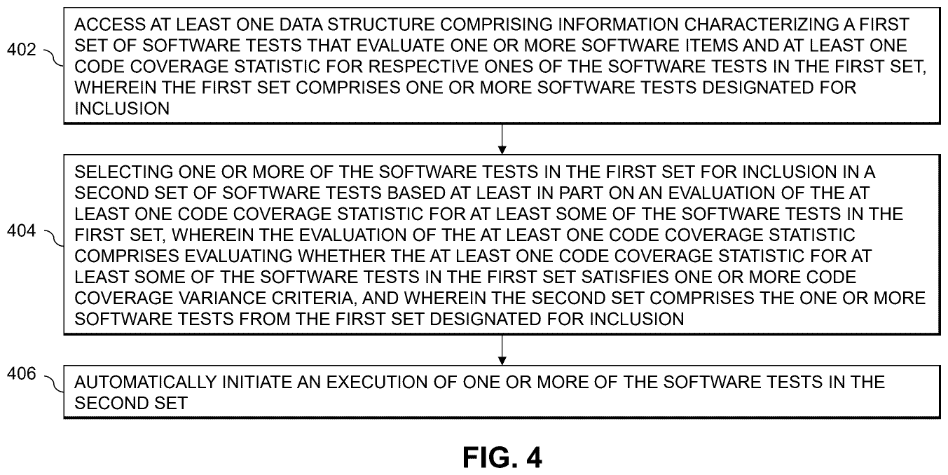

FIG. 4 is a flow diagram illustrating an exemplary implementation of a process for automated identification of software tests using code coverage analysis and software tests designated for inclusion in accordance with an illustrative embodiment. In the example of FIG. 4, at least one data structure is accessed in step 402 comprising information characterizing a first set of software tests that evaluate one or more software items and at least one code coverage statistic for respective ones of the software tests in the first set, wherein the first set comprises one or more software tests designated for inclusion.

One or more of the software tests in the first set may be selected for inclusion in a second set of software tests in step 404 based at least in part on an evaluation of the at least one code coverage statistic for at least some of the software tests in the first set, wherein the evaluation of the at least one code coverage statistic comprises evaluating whether the at least one code coverage statistic for at least some of the software tests in the first set satisfies one or more code coverage variance criteria, and wherein the second set comprises the one or more software tests from the first set designated for inclusion.

An execution of one or more of the software tests in the second set may be automatically initiated in step 406.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In at least one embodiment, the at least one code coverage statistic for a given one of the software tests in the first set comprises a coverage statistic for at least a portion of the given software test. The second set may comprise a designated number of software tests for a given iteration. The generating the second set of software tests may comprise adding software tests, from the first set to the second set, having a substantially highest code coverage statistic.

In one or more embodiments, the selecting the one or more software tests in the second set for inclusion in the second set comprises evaluating at least one software test in the second set having a designated (e.g., maximum) code coverage statistic and adding one or more software tests in the second set to the second set until one or more designated code coverage criteria are satisfied. The one or more code coverage variance criteria may evaluate an amount of unique code coverage provided by a given software test.

In some embodiments, the second set of software tests comprises a first group of software tests having a first designated code coverage statistic for execution using a first schedule and a second group of software tests having a second designated code coverage statistic for execution using a second schedule, wherein the first designated code coverage statistic is lower than the second designated code coverage statistic and wherein the first schedule executes the first group of software tests more frequently than the second schedule executes the second group of software tests. The second set of software tests may converge to a set of software tests satisfying one or more designated code coverage criteria. The automatically initiating the execution of the one or more software tests in the second set may comprise initiating an execution of the one or more software tests from the first set designated for inclusion.

The particular processing operations and other network functionality described in conjunction with FIGS. 3 and 4, for example, are presented by way of illustrative example only, and should not be construed as limiting the scope of the disclosure in any way. Alternative embodiments can use other types of processing operations for automated identification of software tests using code coverage analysis and software tests designated for inclusion. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Embodiments described herein can provide improved techniques for automated identification of software tests using code coverage analysis and software tests designated for inclusion. Improved techniques for automatic software test identification are provided in at least some embodiments that identify a substantially smallest group of software tests that provide the substantially best test coverage. One or more types of code coverage may be employed, with the most popular being, for example, line coverage, statement coverage, function coverage, and branch coverage. In contrast, existing software testing techniques tend to be scenario-based and not oriented toward code coverage. The code coverage of all the tests in a given software test library can be measured. The coverage of each test and the test coverage of all the tests together can be computed. The disclosed automatic software test identification techniques aim to find a minimal set of tests that achieves a maximum (or designated) total code coverage.

One or more embodiments of the disclosure provide improved methods, apparatus and computer program products for automated identification of software tests using code coverage analysis and software tests designated for inclusion. The foregoing applications and associated embodiments should be considered as illustrative only, and numerous other embodiments can be configured using the techniques disclosed herein, in a wide variety of different applications.

It should also be understood that the disclosed techniques for automated identification of software tests using code coverage analysis and software tests designated for inclusion, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated identification of software tests using code coverage analysis and software tests designated for inclusion may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based automatic software test identification engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based automatic software test identification platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

Illustrative embodiments of processing platforms will now be described in greater detail with reference to FIGS. 5 and 6. These platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. Such implementations can provide automatic software test identification functionality of the type described above for one or more processes running on a given one of the VMs. For example, each of the VMs can implement control logic for automatic software test identification and associated functionality for executing such identified software tests.

An example of a hypervisor platform that may be used to implement a hypervisor within the virtualization infrastructure 504 is a compute virtualization platform which may have an associated virtual infrastructure management system such as server management software. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such implementations can provide automatic software test identification functionality of the type described above for one or more processes running on different ones of the containers. For example, a container host device supporting multiple containers of one or more container sets can implement one or more instances of control logic for automatic software test identification and associated functionality for executing such identified software tests.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises at least a portion of the given system and includes a plurality of processing devices, denoted 602-1, 602-2, 602-3, . . . 602-K, which communicate with one another over a network 604. The network 604 may comprise any type of network, such as a WAN, a LAN, a satellite network, a telephone or cable network, a cellular network, a wireless network such as WiFi or WiMAX, or various portions or combinations of these and other types of networks.

The processing device 602-1 in the processing platform 600 comprises a processor 610 coupled to a memory 612. The processor 610 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 612, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 5 or 6, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing at least one data structure comprising information characterizing a first set of software tests that evaluate one or more software items and at least one code coverage statistic for respective ones of the software tests in the first set, wherein the first set comprises one or more software tests designated for inclusion;
selecting one or more of the software tests in the first set for inclusion in a second set of software tests based at least in part on an evaluation of the at least one code coverage statistic for at least some of the software tests in the first set, wherein the evaluation of the at least one code coverage statistic comprises evaluating whether the at least one code coverage statistic for at least some of the software tests in the first set satisfies one or more code coverage variance criteria, and wherein the second set comprises the one or more software tests from the first set designated for inclusion; and
automatically initiating an execution of one or more of the software tests in the second set;
wherein the method is performed by at least one processing device comprising a processor coupled to a memory.

2. The method of claim 1, wherein the at least one code coverage statistic for a given one of the software tests in the first set comprises a coverage statistic for at least a portion of the given software test.

3. The method of claim 1, wherein the second set comprises a designated number of software tests for a given iteration.

4. The method of claim 1, wherein the generating the second set of software tests comprises adding software tests having a substantially highest code coverage statistic from the first set to the second set.

5. The method of claim 1, wherein the selecting the one or more software tests in the second set for inclusion in the second set comprises evaluating at least one software test in the second set having a designated code coverage statistic and adding one or more software tests in the second set to the second set until one or more designated code coverage criteria are satisfied.

6. The method of claim 1, wherein the one or more code coverage variance criteria evaluate an amount of unique code coverage provided by a given software test.

7. The method of claim 1, wherein the second set of software tests comprises a first group of software tests having a first designated code coverage statistic for execution using a first schedule and a second group of software tests having a second designated code coverage statistic for execution using a second schedule, wherein the first designated code coverage statistic is lower than the second designated code coverage statistic and wherein the first schedule executes the first group of software tests more frequently than the second schedule executes the second group of software tests.

8. The method of claim 1, wherein the second set of software tests converges to a set of software tests satisfying one or more designated code coverage criteria.

9. The method of claim 1, wherein the automatically initiating the execution of the one or more software tests in the second set comprises initiating an execution of the one or more software tests from the first set designated for inclusion.

10. An apparatus comprising:
at least one processing device comprising a processor coupled to a memory;
the at least one processing device being configured to implement the following steps:
accessing at least one data structure comprising information characterizing a first set of software tests that evaluate one or more software items and at least one code coverage statistic for respective ones of the software tests in the first set, wherein the first set comprises one or more software tests designated for inclusion;
selecting one or more of the software tests in the first set for inclusion in a second set of software tests based at least in part on an evaluation of the at least one code coverage statistic for at least some of the software tests in the first set, wherein the evaluation of the at least one code coverage statistic comprises evaluating whether the at least one code coverage statistic for at least some of the software tests in the first set satisfies one or more code coverage variance criteria, and wherein the second set comprises the one or more software tests from the first set designated for inclusion; and
automatically initiating an execution of one or more of the software tests in the second set.

11. The apparatus of claim 10, wherein the generating the second set of software tests comprises adding software tests having a substantially highest code coverage statistic from the first set to the second set.

12. The apparatus of claim 10, wherein the selecting the one or more software tests in the second set for inclusion in the second set comprises evaluating at least one software test in the second set having a designated code coverage statistic and adding one or more software tests in the second set to the second set until one or more designated code coverage criteria are satisfied.

13. The apparatus of claim 10, wherein the one or more code coverage variance criteria evaluate an amount of unique code coverage provided by a given software test.

14. The apparatus of claim 10, wherein the second set of software tests comprises a first group of software tests having a first designated code coverage statistic for execution using a first schedule and a second group of software tests having a second designated code coverage statistic for execution using a second schedule, wherein the first designated code coverage statistic is lower than the second designated code coverage statistic and wherein the first schedule executes the first group of software tests more frequently than the second schedule executes the second group of software tests.

15. The apparatus of claim 10, wherein the automatically initiating the execution of the one or more software tests in the second set comprises initiating an execution of the one or more software tests from the first set designated for inclusion.

16. A non-transitory processor-readable storage medium having stored therein program code of one or more software programs, wherein the program code when executed by at least one processing device causes the at least one processing device to perform the following steps:
accessing at least one data structure comprising information characterizing a first set of software tests that evaluate one or more software items and at least one code coverage statistic for respective ones of the software tests in the first set, wherein the first set comprises one or more software tests designated for inclusion;
selecting one or more of the software tests in the first set for inclusion in a second set of software tests based at least in part on an evaluation of the at least one code coverage statistic for at least some of the software tests in the first set, wherein the evaluation of the at least one code coverage statistic comprises evaluating whether the at least one code coverage statistic for at least some of the software tests in the first set satisfies one or more code coverage variance criteria, and wherein the second set comprises the one or more software tests from the first set designated for inclusion; and
automatically initiating an execution of one or more of the software tests in the second set.

17. The non-transitory processor-readable storage medium of claim 16, wherein the generating the second set of software tests comprises adding software tests having a substantially highest code coverage statistic from the first set to the second set.

18. The non-transitory processor-readable storage medium of claim 16, wherein the selecting the one or more software tests in the second set for inclusion in the second set comprises evaluating at least one software test in the second set having a designated code coverage statistic and adding one or more software tests in the second set to the second set until one or more designated code coverage criteria are satisfied.

19. The non-transitory processor-readable storage medium of claim 16, wherein the second set of software tests comprises a first group of software tests having a first designated code coverage statistic for execution using a first schedule and a second group of software tests having a second designated code coverage statistic for execution using a second schedule, wherein the first designated code coverage statistic is lower than the second designated code coverage statistic and wherein the first schedule executes the first group of software tests more frequently than the second schedule executes the second group of software tests.

20. The non-transitory processor-readable storage medium of claim 16, wherein the automatically initiating the execution of the one or more software tests in the second set comprises initiating an execution of the one or more software tests from the first set designated for inclusion.
